(19) United States
(12) Patent Application Publication
(10) Pub. No.: US 2022/0161281 A1
(43) Pub. Date: May 26, 2022

(54) DEVICE FOR DISPENSING A VORTEX WATER JET

(71) Applicant: NIKLES INTER AG, Aesch (CH)

(72) Inventor: Gerhard NIKLES, Aesch (CH)

(21) Appl. No.: 17/523,035

(22) Filed: Nov. 10, 2021

(30) Foreign Application Priority Data
Nov. 24, 2020 (IT) 102020000028211

(51) Int. Cl. B05B 3/08; B05B 1/06; B05B 1/20

(52) U.S. Cl. CPC B05B 3/08; B05B 1/202; B05B 1/06

(57) ABSTRACT

A device for dispensing a vortex water jet has a device body in which a water swirling path is obtained. The water swirling path has a swirling chamber defined between two opposite side walls which axially extend between a plurality of water inlet ends circumferentially arranged about the swirling chamber, and a water outlet end. The water swirling path has a plurality of chamber supply channels which are angled with respect to the swirling chamber, each chamber supply channel leading into a water inlet end of the swirling chamber. The device generates an output swirling water jet having shapes with particular aesthetical effect.

### CROSS-REFERENCE TO RELATED APPLICATION

This application claims priority to Italian Patent Application No. 102020000028211 filed on Nov. 24, 2020, the entire contents of which is hereby incorporated in its entirety by reference.

### FIELD OF THE INVENTION

The present invention relates to a device for dispensing a water jet in the form of to a vortex, for example for obtaining hand showers, showerheads, body sprays, or other dispensing devices.

### BACKGROUND OF THE INVENTION

Dispensing devices configured to generate one or more water jets in the form of a vortex are already known. According to the operating pressure, water jets may be particularly gentle on the skin or they may have a massaging effect, as in the case of body sprays.

Certain embodiments of dispensing devices use rotating blade members which, when hit by a flow of water, put the flow of water into rotation to create the water vortex. Other embodiments use rotating nozzles oriented so as to be slanted from one another.

In any case, all known embodiments require the use of rotating members; therefore, they are complex and costly to construct and more exposed to breakdowns or stops, for example due to the formation of limescale.

### SUMMARY OF THE INVENTION

It is the object of the present invention to provide a device for dispensing a water jet in the form of a vortex having a particularly simple and compact structure, consisting of a reduced number of components, and having increased reliability compared to known devices.

Such an object is achieved by a dispensing device as described and claimed herein. Advantageous embodiments of the dispensing device according to the present invention are also described.

### BRIEF DESCRIPTION OF THE DRAWINGS

The features and advantages of the dispensing device according to the present invention will become apparent from the following description of preferred embodiments thereof, given only by way of non-limiting, indicative example, with reference to the accompanying drawings, in which:

FIG. 1 is an axonometric bottom view of a variant of a dispensing device according to the present invention;

FIG. 2 is an exploded top view of the dispensing device in FIG. 1;

FIG. 3 is an exploded bottom view of the dispensing device in FIG. 1;

FIG. 4 is an axonometric section view of the dispensing device in FIG. 1;

FIG. 5 is a section view of the dispensing device in FIG. 1 in use, in which an output vortex is formed with an input low-pressure water jet, the vortex tending to close on itself, forming a balloon;

FIG. 6 is an axonometric bottom view of a further variant of a dispensing device according to the present invention;

FIG. 7 is an exploded top view of the dispensing device in FIG. 5;

FIG. 8 is an exploded bottom view of the dispensing device in FIG. 5;

FIG. 9 is a bottom view of an inner component of the dispensing device in FIG. 1 and FIG. 5, in particular of a swirling plate 102; and

FIG. 10 is a section view of the dispensing device in FIG. 1 in use, in which an output vortex is formed with an input high-pressure water jet, the vortex tending to remain open, forming a cone.

### DETAILED DESCRIPTION

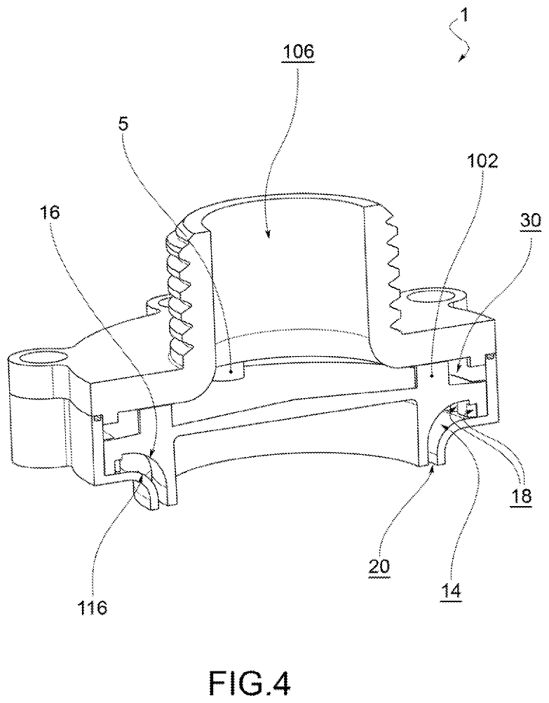

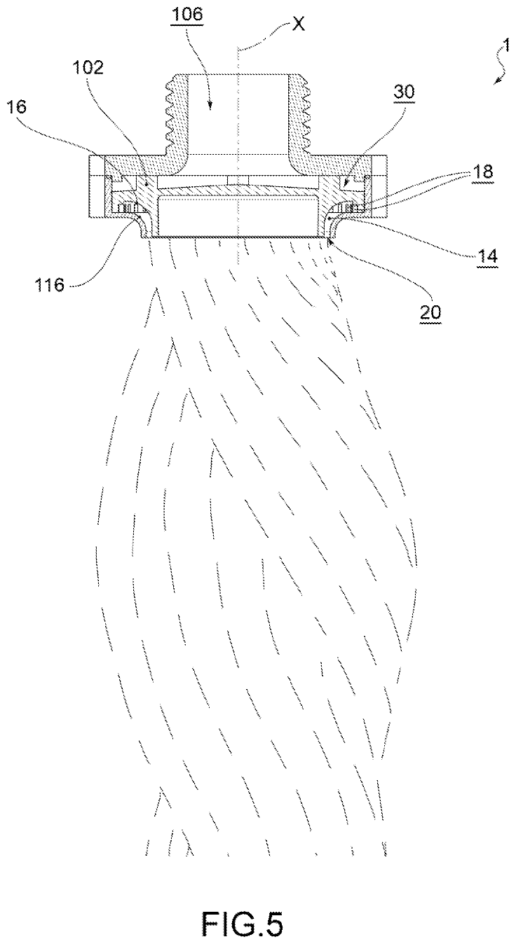

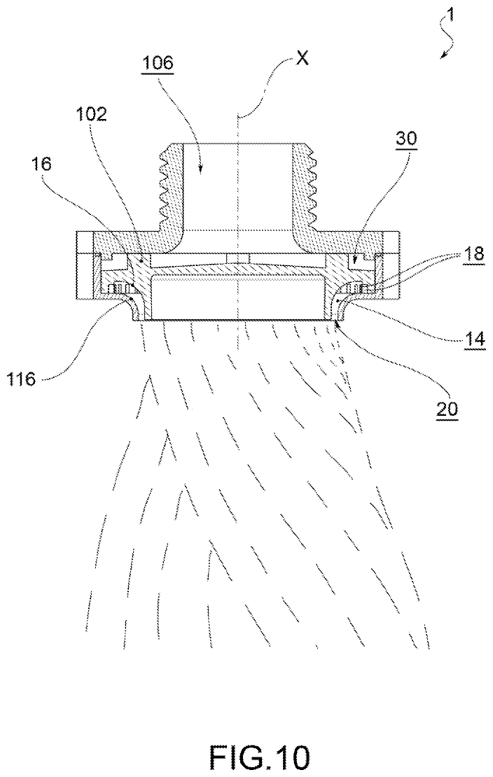

A device for dispensing a water jet in the form of a vortex according to the present invention is indicated as a whole in the drawings by reference numeral 1. In particular, as shown in FIG. 4, the dispensing device 1 according to the present invention emits a water jet in which the vortex defines a shape with a particular aesthetical and dramatic effect, for example a cone (as in FIG. 10) or a balloon (as in FIG. 5).

In a general embodiment, the device 1 comprises a device body 10 in which a water swirling path 12 is obtained.

The water swirling path 12 comprises a swirling chamber 14 having an annular cross section.

The swirling chamber 14 is defined between two opposite side walls 16, 116 which axially extend between a plurality of water inlet ends 18 and an annular water outlet end 20.

The water inlet ends 18 are circumferentially arranged all about the swirling chamber 14.

The two opposite side walls 16, 116 are concave so that the swirling chamber 14 has a concave cross section with a concavity facing outwards, as clearly shown in FIG. 4.

Moreover, the concave cross section of the swirling chamber 14 has a progressively decreasing diameter, from the water inlet ends 18 towards the annular water outlet end 20.

The longitudinal axis of the dispensing device 1 being defined as X, the water inlet ends 18 define a plurality of transverse water inlets, i.e., the water inlet ends 18 are arranged transversely. The annular water outlet end 20 instead defines an axial water outlet, i.e., the annular water outlet end 20 is arranged axially.

The water swirling path 12 further comprises a plurality of chamber supply channels 24 obtained in the device body 10. The chamber supply channels 24 are fluidly connectable to a water feeding conduit and lead to the water inlet ends 18 of the swirling chamber 14.

The chamber supply channels 24 are angled with respect to the swirling chamber 14, i.e., they do not intersect the swirling chamber either frontally or tangentially, rather in inclined manner.

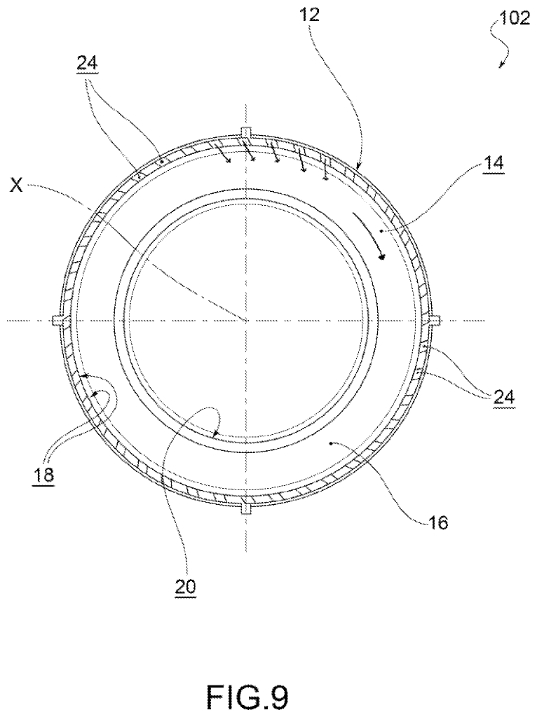

As shown in FIG. 9, the maximum size of the chamber supply channels 24, e.g., the width, is much less than the radial width of the swirling chamber 14. Thereby, the chamber supply channels 24 provide a series of pressurized water inlets to the swirling chamber 14. For example, the width of the chamber supply channel 24 is between 10% and 20% of the radial width of the swirling chamber 14.

The number of the chamber supply channels 24 is quite high, for example between 20 and 60, preferably between 30 and 50.

The chamber supply channels 24 are arranged close to one another in a continuous sequence.

The chamber supply channels 24 are uniformly distributed circumferentially about the swirling chamber 14.

Moreover, the chamber supply channels 24 are all inclined in the same manner with respect to the swirling chamber 14. Thereby, the chamber supply channels 24 provide a series of water inlets which intersect in the swirling chamber 14.

The chamber supply channels 24 are obtained so that the rotation directions of the adjacent water flows in the swirling chamber 14 coincide. Thereby, the rotation directions of the adjacent water jets are concordant to form an overall uniform and homogeneous vortex in the swirling chamber 14.

Advantageously, therefore, the dispensing device 1 internally comprises a water swirling path 12, defined by an annular swirling chamber 14 circumferentially fed by an increased number of inclined, i.e., angled, chamber supply channels 24 having reduced cross section.

Therefore, as shown in FIG. 9, the idea at the basis of the present invention is introducing a plurality of pressurized water flows into a swirling chamber 14 according to a direction inclined with respect to the swirling chamber so that each water flow meets with the preceding water flow in the swirling chamber 14 and is pushed thereby in a circular direction to form a single pressurized water flow which, guided by the two opposite side walls 16, 116, forms an output fast vortex from the swirling chamber. The cross section of the annular water outlet end 20 is selected so that the rotation of the water flow is maintained. The output vortex is provided with an increased rotation speed so as to expand, once it has passed the annular water outlet end 20, to form a balloon shape, as shown in FIG. 4.

Moreover, in an embodiment, each chamber supply channel 24 is delimited by parallel side walls.

In an embodiment, the swirling chamber 14 extends about the longitudinal axis X of the dispensing device 1.

In an embodiment shown in the drawings, the chamber supply channels 24 are obtained in the thickness of a swirling plate 102 of the device body 10.

Moreover, in the embodiment shown, the chamber supply channels 24 are fed by an upper distribution chamber 30 communicating with the water feeding conduit and, for example, obtained in the thickness of the swirling plate 102 as well.

The device body 10 may comprise an upper closing cap 104 overlapping a lower closing cap 103. The swirling plate 102 is arranged between the upper closing cap 104 and the lower closing cap 103.

A water inlet passageway 106 open onto the upper distribution chamber 30 and connectable to a water feeding conduit is defined between the upper closing cap 104 and the swirling plate 102.

The swirling chamber 14 is defined between the swirling plate 102 and lower closing cap 103. Therefore, the swirling chamber 14 is defined between the side wall 16, belonging to the swirling plate 102, and the side wall 116, belonging to the lower closing to cap 103.

The swirling plate 102 comprises a discoid body having upper spacers 5 protruding at the top to keep a free space between the upper closing cap 104 and the swirling plate 102.

The swirling plate 102 comprises an annular peripheral wall 6 protruding at the bottom from the discoid body, in the thickness of which the chamber supply channels 24 are obtained.

The swirling plate 102 comprises an annular central wall 7 protruding at the bottom from the discoid body, which is the side wall 16 of the swirling chamber 14.

The swirling plate 102 comprises radial spacers 8 protruding laterally from the annular peripheral wall 6 to keep a free space between the upper closing cap 104 and/or from the lower closing cap 103 and the swirling plate 102.

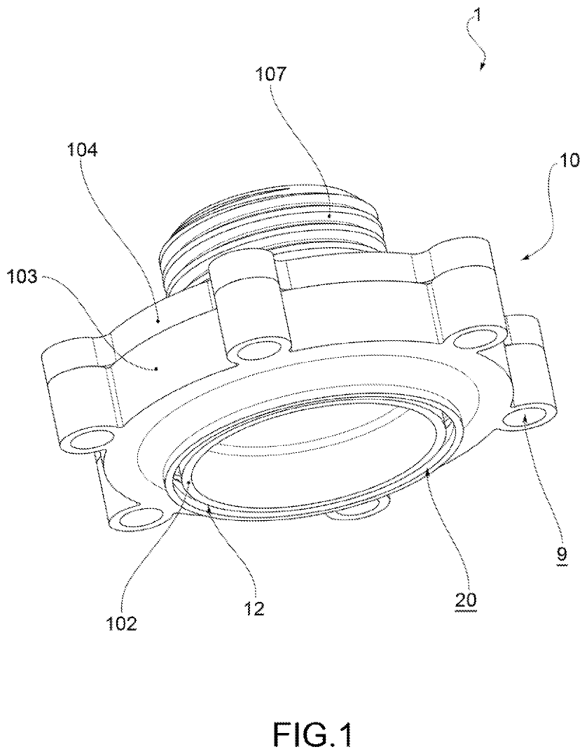

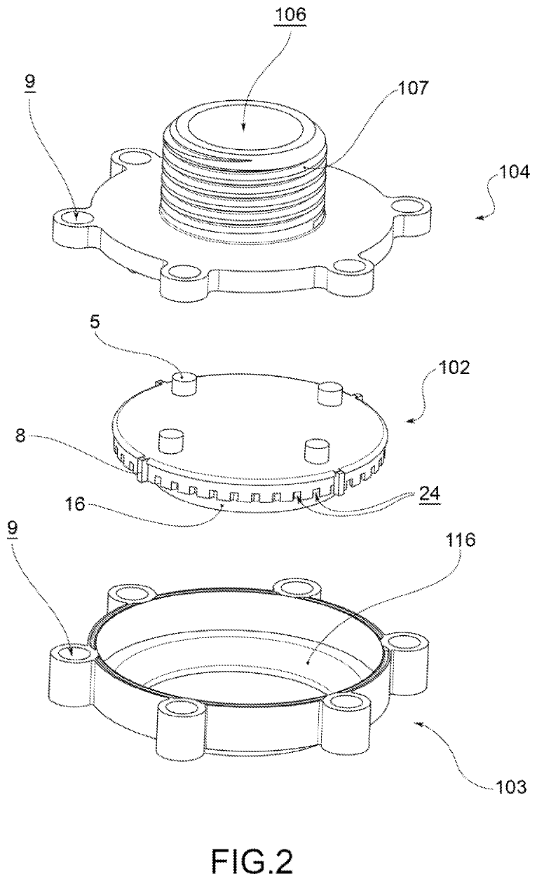

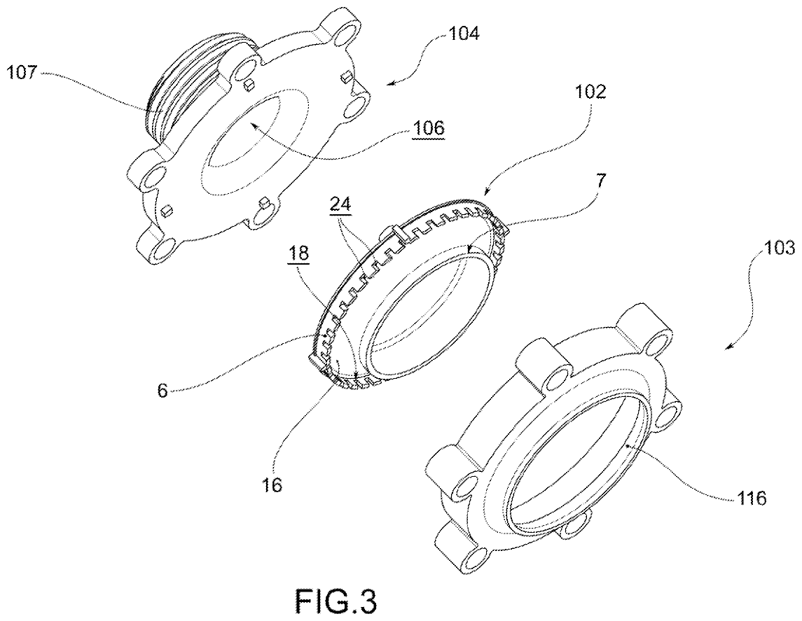

In the example in FIGS. 1 to 5, the water inlet passageway 106 is connectable to a water feeding conduit by a threaded connection 107.

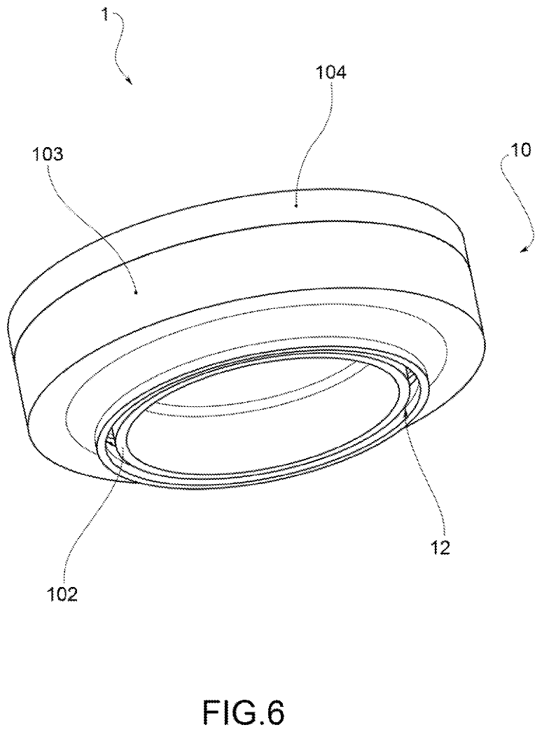

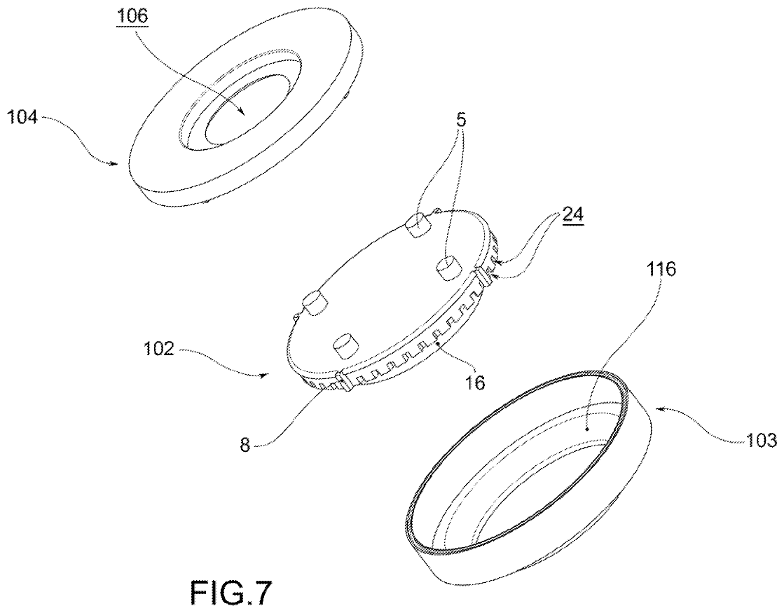

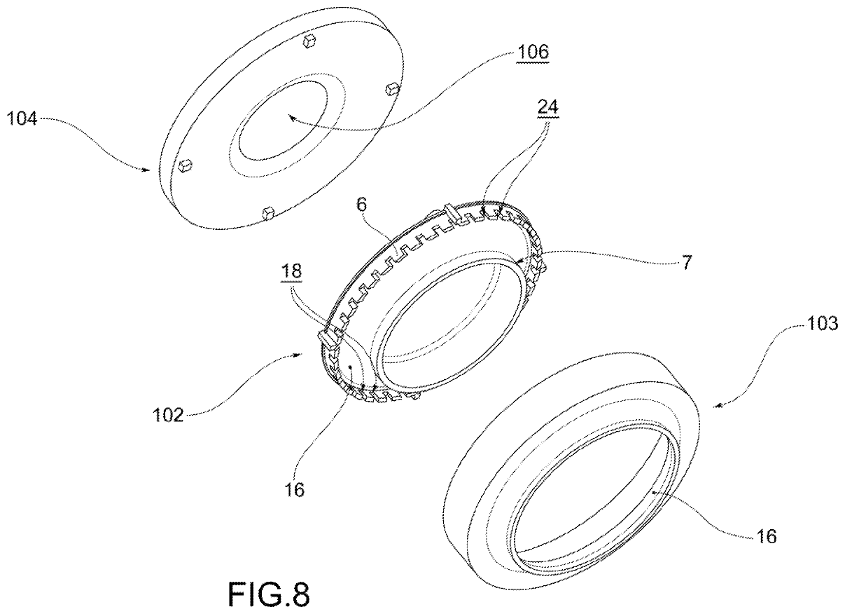

In the example in FIGS. 6 to 8, the water inlet passageway 106 is connectable to a hand shower.

In the example in FIGS. 1 to 5, the upper closing cap 104 and the lower closing cap 103 are mechanically connected, for example by screws inserted in specific connection holes 9.

In the example in FIGS. 6 to 8, the upper closing cap 104 and the lower closing cap 103 are fastened to each other, for example by welding or gluing.

Innovatively, a dispensing device according to the present invention has a particularly simple and compact structure and consists of a reduced number of fixed components, i.e., not rotating, and therefore is more reliable than the known devices.

Advantageously, the dispensing device 1 according to the present invention internally comprises a water swirling path 12 defined by an annular swirling chamber 14 circumferentially fed by an increased number of inclined chamber supply channels 24 having reduced cross section, capable of generating an output swirling water jet which defines a shape with a particular aesthetical and dramatic effect, for example a cone or a balloon.

Those skilled in the art may make changes and adaptations to the embodiments of the dispensing device according to the present invention, or can replace elements with others which are functionally equivalent without departing from the scope of protection as described and claimed herein. All the features described above as belonging to a possible embodiment may be implemented irrespective of the other embodiments described.

What is claimed is:

1. A device for dispensing a vortex water jet, comprising a device body in which a water swirling path comprising a swirling chamber is obtained; wherein
said swirling chamber is defined between two opposite side walls which axially extend between a plurality of water inlet ends circumferentially arranged about the swirling chamber, and a water outlet end; and wherein
said water swirling path comprises a plurality of chamber supply channels which are angled with respect to the swirling chamber, each chamber supply channel of said plurality of chamber supply channels being fluidly connectable to a water feeding conduit and leading into a water inlet end of the swirling chamber.

2. The device of claim 1, wherein the chamber supply channels are identically inclined so as to provide a series of converging inlets to form an overall uniform vortex in the swirling chamber.

3. The device of claim 1, wherein a width of the chamber supply channels is between 10% and 20% of a radial width of the swirling chamber.

4. The device of claim 1, wherein a number of the chamber supply channels ranges from 20 to 60.

5. The device of claim 1, wherein the water inlet ends are transversely arranged with respect to the swirling chamber and the water outlet end is axially arranged with respect to the swirling chamber.

6. The device of claim 1, wherein said two opposite side walls are concave so that the swirling chamber has a concave cross section with a concavity facing outwards.

7. The device of claim 6, wherein said concave cross section decreases towards the water outlet end.

8. The device of claim 1, further comprising a swirling plate arranged between an upper closing cap and a lower closing cap, wherein the swirling plate is a discoid body provided with an annular peripheral wall, the chamber supply channels being formed in a thickness of said swirling plate.

9. The device of claim 8, wherein the swirling chamber is defined between the swirling plate and the lower closing cap.

10. The device of claim 8, wherein the swirling plate comprises a central wall forming one of the two opposite side walls of the swirling chamber.

11. The device of claim 8, wherein the lower closing cap comprises a central wall forming one of the two opposite side walls of the swirling chamber.
